(19) United States
(12) Patent Application Publication
(10) Pub. No.: US 2011/0184619 A1
(43) Pub. Date: Jul. 28, 2011

(54) VEHICLE CONTROLLING APPARATUS AND TRAIN

(75) Inventors: Madoka KAMATA, Tokyo (JP); Sumiko Kominato, Kodaira-shi (JP); Hideaki Nameki, Mitaka-shi (JP); Junko Yamamoto, Yokohama-shi (JP)

(73) Assignee: KABUSHIKI KAISHA TOSHIBA, TOKYO (JP)

(21) Appl. No.: 13/084,700

(22) Filed: Apr. 12, 2011

Related U.S. Application Data
(63) Continuation of application No. PCT/JP2009/067865, filed on Oct. 15, 2009.

(30) Foreign Application Priority Data
Oct. 16, 2008 (JP) 2008-267612

(51) Int. Cl. B61L 23/14; B61L 3/00; G06F 19/00

(52) U.S. Cl. 701/70; 246/182 B; 246/4

(57) ABSTRACT

According to one embodiment, a vehicle controlling apparatus includes a storage unit, a setting unit, a changing unit, and a controller. The storage unit stores plurality sets of target information. The setting unit sequentially sets at least part of the plurality of target information to be satisfied until a vehicle stops in a given position based on the part of the plurality of target information. The changing unit sequentially changes one target information to next target information in series in the part of the plurality of target information when the one target information is satisfied. The controller which controls an operation of the vehicle so that the operation satisfies the target set by the changing unit.

### CROSS REFERENCE TO RELATED APPLICATIONS

This is a Continuation Application of PCT Application No. PCT/JP2009/067865, filed Oct. 15, 2009, which was published under PCT Article 21(2) in Japanese.

This application is based upon and claims the benefit of priority from Japanese Patent Application No. 2008-267612, filed Oct. 16, 2008; the entire contents of which are incorporated herein by reference.

### FIELD

Embodiments described herein relate generally to a vehicle controlling apparatus that automatically controls a vehicle, such as a train, to stop in a preset position.

### BACKGROUND

In recent years, a vehicle controlling apparatus is proposed to control a vehicle operation steadily and reduce operational delays. The vehicle may be a train. For example, in an automatic train controlling apparatus, control of a train such as fixed-position-stopping control for stopping a train in a preset position is performed. In a recent train timetable with a tendency for being overcrowded condition, if a train overruns a preset stop position, a train operation delay is caused for adjusting the stop position of the train. Furthermore, for security of passengers in the platform of each station, doors called platform screen doors are progressively installed in the platforms of each station. If such platform screen doors are installed on the platform of the station, it is necessary for a train to precisely stop according to the installation position of the platform screen door.

Most conventional vehicle controlling apparatuses has a function to control a train to stop a preset target point. For example, Japanese Patent Publication JP-03-117305 discloses that a conventional vehicle controlling apparatus compares a control result in a case where the present control instruction is held with a control result in a case where the present control instruction is changed by a preset amount, and consequently determines a control instruction to control a train.

However, in recent years, it is often required to further enhance the control precision. For example, it is required to achieve high precision for control of stopping a train in a fixed position. Also, in recent years, it is increasingly required to reduce the time to stop a train after the train passes a certain point so as not to disrupt a train system. Further, it is sometimes required to adjust slowing-down time by taking a ride or operating condition into consideration.

### BRIEF DESCRIPTION OF THE DRAWINGS

FIG. 1 is a block diagram showing an example of the configuration of an automatic train operating apparatus according to an embodiment.

FIG. 2 is a view showing a control example in a case where one fixed position is set as a stop position target.

FIG. 3 is a view showing a control example in a case where a plurality of targets are sequentially set as a control target.

FIG. 4A illustrates a control example for reaching each target.

FIG. 4B illustrates a control example for reaching each target.

FIG. 5 is a flowchart for illustrating an operation example of fixed-point control as operating control in the automatic train operation apparatus.

FIG. 6 is a view showing a setting example of a permissible range for each target.

### DETAILED DESCRIPTION

In general, according to one embodiment, exemplary embodiments will be described with reference to the drawings.

FIG. 1 is a block diagram showing an example of the configuration of an automatic train controlling apparatus 2 as a vehicle controlling apparatus installed in a train 1. The train 1 may be a commuter train or a locomotive.

As shown in FIG. 1, the automatic train controlling apparatus 2, tacho-generator (TG) 11, on-vehicle unit 12 such as a pickup coil, control device 13, brake device 14, ATC (Automatic Train Control) device 15, ATC receiver 16 are installed in the train 1. The tacho-generator 11, on-vehicle unit 12, control device 13, brake device 14, ATC device 15, and ATC receiver 16 may be hardware modules and controlled by the automatic train controlling apparatus 2.

The automatic train controlling apparatus 2 includes a database 21, speed and position detecting unit 31, target setting unit 32 and control instructing unit 33 and the like. The automatic train controlling apparatus 2 with the above configuration is installed in a first car of the train 1, for example. The database 21 is formed in a storage device installed in the train 1. The storage device may be a hard disk device. The speed and position detecting unit 31, target setting unit 32, and control instructing unit 33 are realized by operating circuits and the like connected to the respective hardware.

The tacho-generator 11 is attached to a shaft of a wheel. The speed of the train 1 is specified by a signal detected by the tacho-generator 11. The on-vehicle unit 12 detects a signal from an on-ground unit such as a transponder placed on a track. The position of the train 1 is specified by a signal detected by the on-vehicle unit 12.

The control device 13 controls running of the train 1. The train 1 is accelerated and run under the control of the control device 13. The brake device 14 brakes the train 1. The train 1 is decelerated and stopped under the control of the brake device 14. For example, the brake device 14 is configured by an electrical brake and an air brake. The electrical brake and the air brake respectively may be a regenerative brake and a friction brake. In this case, the brake device 14 switches the electrical brake and the air brake when decelerating and stopping the train 1.

The ATC device 15 controls the train 1 so that the train 1 does not overrun. The ATC receiver 16 that receives a signal transmitted from a rail as the track on which the train 1 runs is connected to the ATC device 15. The ATC device 15 determines a speed limit based on the signal received via the ATC receiver 16 and determines the present speed based on the signal detected by the tacho-generator 11 attached to the shaft. When the present speed reaches or exceeds the speed limit, the ATC device 15 outputs an emergency brake instruction signal to the brake device 14. Further, the ATC device 15 outputs information obtained from the signal received via the ATC receiver 16 to the target setting unit 32 or control instructing unit 33.

The database (DB) 21 stores various data items to be used for controlling the train 1 when the train 1 runs. For example, route data, dynamic characteristic data, control data and the like are stored in the database 21. The route data is composed of plural types of data relating to the route on which the train 1 runs, and may includes the present position data on the route based on a signal detected by the on-vehicle unit 12, the stop target position data of each station, slope, and curve data.

Further, the dynamic characteristic data may be a brake characteristic of the train 1 set based on the test-run and design specification of the train 1. Concretely, the dynamic characteristic data may includes a standard value (initial value) of the acceleration and deceleration of the train 1 corresponding to a notch instruction value indicating the strength of the brake, a response delay with respect to a notch instruction, weight of the train 1, and passenger load factor, coefficients of a slope resistance equation or curve resistance equation and the like. That is, the control content in which the vehicle passes a target point at a target speed is realized by using the information stored in the database 21, present position and present speed.

The speed and position detecting unit 31 outputs a detected speed signal and a detected position signal. For example, the speed and position detecting unit 31 detects the speed based on a signal input from the tacho-generator 11 and outputs the detected speed signal. Further, the speed and position detecting unit 31 inputs a signal from the on-ground unit placed on the track via the on-vehicle unit 12, detects the present position based on a signal input from the tacho-generator 11 and a signal input from the on-ground unit and outputs the detected position signal. In this case, the detected position signal indicates the present position of the train 1.

The target setting unit 32 properly sets at least one set of a target point and a target speed at the target point. Further, the at least one set of the target point and the target speed can previously be stored, by the target setting unit 32, in a storage device such as the database 21. Also, the target point and the target speed can be calculated at a given timing. For example, when controlling the train 1 running at a speed to stop a given position of a station, a target position for stopping the train 1 at the given position and route data up to the target position is obvious. Therefore, it is preferable to store a plurality of targets up to the target position in the database 21 for stopping the train 1, being on the normal operation, at the given position.

When the train 1 is stopped or decelerated at a given timing, the target setting unit 32 properly calculates a plurality of targets for controlling the train 1 to stop or decelerate up to the target position. It is assumed that the distance between the targets or the number of targets up to the target position is separately set. The precision may be enhanced as the number of targets is increased. However, if the number of targets is excessively increased, switching of the notches is frequently performed, the ride becomes rough, and the control of the train 1 becomes complicated. Therefore, the target setting unit 32 may calculate the number of targets or target distance between two adjacent targets in view of comfort for passengers on the train 1 and controllability of the train 1 to stop the target position.

The control instructing unit 33 gives a control instruction to the control device 13 and brake device 14. The control instructing unit 33 controls the control device 13 and brake device 14 based on data supplied from the respective portions to perform drive control of the train 1. The control instructing unit 33 calculates a running schedule to reach the target each time a target is given from the target setting unit 32 and gives a control instruction to the brake device 14 according to the calculated running schedule. In the present automatic train controlling apparatus 2, the target setting unit 32 sets a plurality of targets used up to the target position. The control instructing unit 33 sequentially changes over from one target to the next target in accordance with the plurality of target set by the target setting unit 32. That is, the target is sequentially changed over to a next target each the train 1 reaches time one target.

Next, the principle on how the automatic train controlling apparatus 2 controls the train 1 to stop the target position is explained in detail.

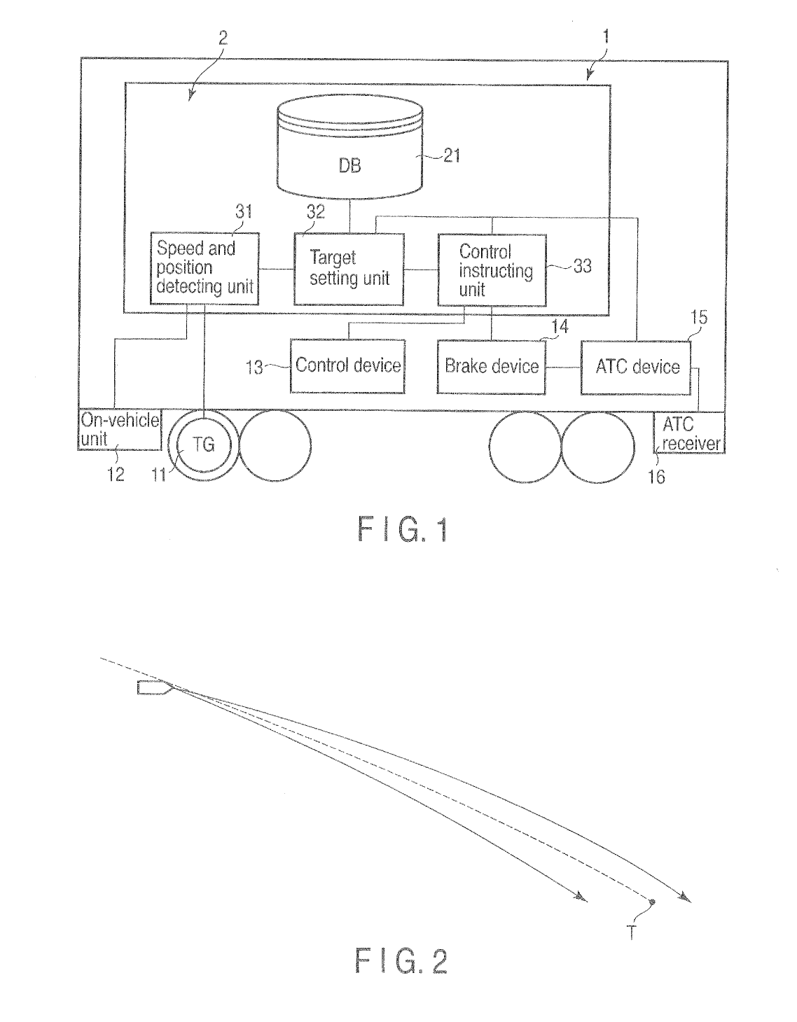

FIG. 2 is a view showing a control example in a case where one target position is set as a given position at a station.

As shown in FIG. 2, deceleration is controlled so that the train 1 can follow the dotted line and get to a target position T. Generally, as shown by arrows in FIG. 2, it might occur that a trajectory of the train 1 deviates from the dotted line. It is readily predictable that the degree of the deviation from the dotted line will be larger as the distance between the current position of the train 1 and the target position is larger, and consequently, the control of the train 1 will be difficult. For example, when control is performed to follow the pattern indicated by the dotted lines, it is predictable that fluctuations become larger to follow the dotted line as the distance between the current position of the train 1 and the target position is larger.

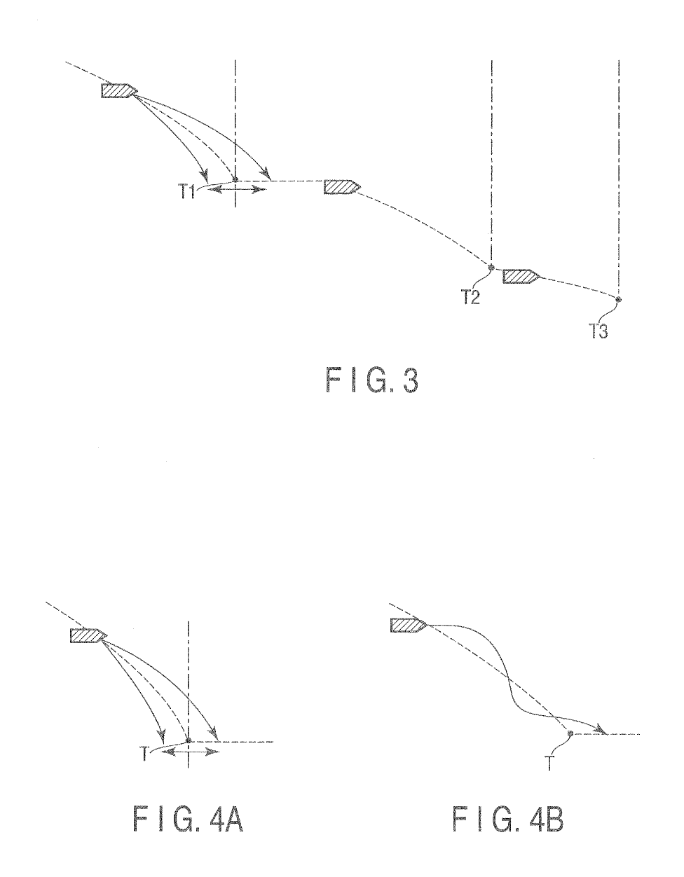

On the other hand, FIG. 3 is a view showing a control example when first target T1, second target T2, and third target (stop position target) T3 are sequentially set as targets.

In the example shown in FIG. 3, the each target is composed of position and speed. If position x is set as an x axis and speed v is set as a y axis, respective targets T1, T2, T3 are indicated by the xy coordinate. For example, first target T1 is expressed by (x1, v1), second target T2 is expressed by (x2, v2), and third target T3 is expressed by (x3, v3).

When the targets, to be satisfied by the train 1 running from the current position to a target position, are set as shown in FIG. 3, the distance between two adjacent targets does not become long distance. Therefore, the position and speed of the train 1 controlled in accordance with the targets hardly deviate from the current target. That is, the control to the train 1 to follow the targets will be facilitated and the high precision to follow the targets will be feasible or satisfied.

That is, in the automatic train controlling apparatus 2, high precision can be achieved for a target position such as a stop position by changing a plurality of targets in series when controlling the train 1 as shown in FIG. 3. In this case, the train 1 is controlled to accord speed and position of the train 1 with the speed and the position of the target so as to satisfy the respective targets as shown in FIG. 4A is applied. Further, the train 1 is controlled to accord speed and position of the train 1 with the speed and the position of the target by following a target pattern as shown in FIG. 4B.

When controlling the train 1 running at a high speed to stop in accordance with the method as described above at a predetermined target position, the automatic train controlling apparatus 2 can depress behavior of the train 1 by setting a plurality of targets and changing the targets sequentially. Therefore, highly efficient and steady stop control can be realized according to a preset operation timetable. Further, since passage precision when passing a specified point can be securely attained, it is readily expectable that the precision to control the train 1 will be enhanced. For example, the marginal distance can be shortened and further narrowed by narrowing a settled point.

Further, according to the above stop control, since the flexibility is high with respect to setting of the respective targets, various operating configurations and requirements can be easily coped with. For example, in a case that a high priority is given to the control to the ride when stopping the train 1, targets is set so that the train 1 is slowly decelerated to give passengers a comfortable ride. On the other hand, in a case that a high priority is given to a reduction in the stop time, stop control can be realized in a short time while a constant ride is maintained by setting a target that causes the rate of deceleration to be set high in a high-speed range and a target that can permit the constant ride to be maintained in a low-speed range.

Further, the respective targets described above may have permissible ranges. For example, in the example shown in FIG. 3, first target T1 and second target T2 other than target position T3, the final target, such as a stop position may have permissible ranges. That is, if the permissible range for distance x1 of first target T1 is set to β1 and the permissible range for speed v1 of first target T1 is set to α1, a value that is actually reached for first target T1 becomes (x1±β1, v1±α1). Further, if the permissible range for distance x2 of second target T2 is set to x1 and the permissible range for speed v2 of second target T2 is set to α2, a value that is actually reached for second target T2 becomes (x2±β2, v2±α2). However, since final target T3 is a stop position, no permissible range is set. The α1, β1, α2, and β2 are coefficients.

If first target T1 and second target T2 are set to have permissible ranges, the train 1 can readily be controlled. First target T1 and second target T2 are passing targets until the train 1 reaches target position T3. In other words, it is important that the passing targets, such as the first target T1 and second target T2, are subjected to efficient and smooth control to reach a target position, such as the third target T3, rather than complicated control to reach the above targets with high precision. Therefore, overall control for reaching the third target T3 as the final target can be efficiently and easily performed by causing the distances and speeds of first target T1 and second target T2 as the passing targets to have the permissible ranges.

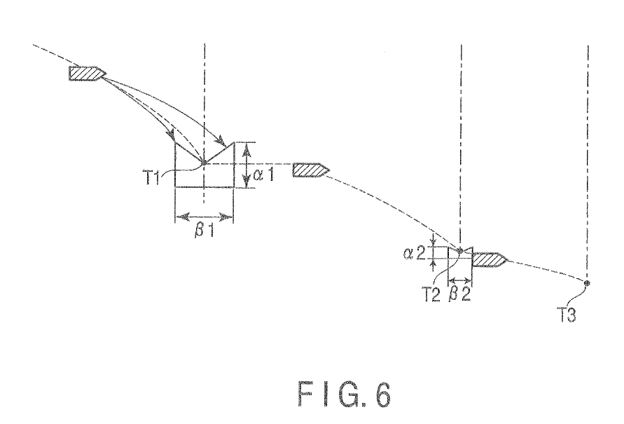

FIG. 6 is a view showing an example on how to set permissible ranges for first target T1 and second target T2.

As shown in FIG. 6, it is preferable to set a value of the permissible range for first target T1 wider than that of the permissible range for second target T2 when permissible ranges are given to the respective targets shown in FIG. 3. That is, since the respective targets are set for controlling the train 1 to reach the target position, it is considered efficient that the permissible ranges of the respective targets before the final target are set narrower as the final target becomes closer. Therefore, as the permissible ranges for the respective targets shown in FIG. 3, values that satisfy α1>α2, β1>β2 as shown in FIG. 6 are considered preferable.

Further, since the actual train control should always be performed based on a combination of the speed and distance, it is preferable to set the permissible range for the target based on a combination of the speed and distance. For example, if constant permissible ranges are simply set for the distance and speed, respectively, it is supposed that the target is satisfied when the permissible range is satisfied even in a case where ideal control is performed towards an actual target. In view of the above situation, as the permissible ranges for first target T1 and second target T2 shown in FIG. 3, it is preferable to set not a simple rectangular region with each target set as the center but a permissible range as shown in FIG. 6.

Further, switching of control to a next target after each target other than the target position has been satisfied is made. In view of this point, in a case where actual control is deviated from ideal control for each target in setting of the permissible range as shown in FIG. 6, control for the target can be changed early if it is within the permissible range. On the other hand, control for the next target can be changed at a point near the target as actual control becomes closer to ideal control for the target in setting of the permissible range as shown in FIG. 6. It can be said that such control is efficient in view of the fact that the target position is satisfied with high precision.

Next, driving control in the automatic train controlling apparatus 2 is explained.

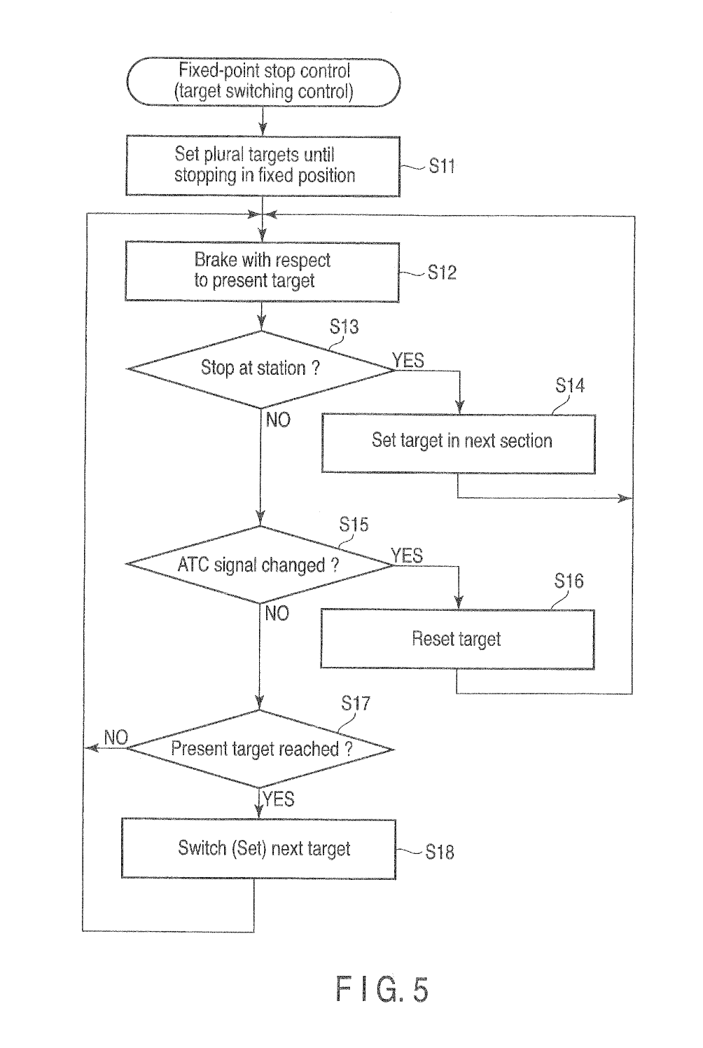

FIG. 5 is a flowchart for illustrating an operation example of fixed-point control as driving control in the automatic train controlling apparatus 2.

First, it is assumed that the automatic train controlling apparatus 2 starts control to stop the train 1 at a station. Information relating to stations where the train 1 stops is stored in the database 21. For example, it is assumed that information indicating a given position as a preset stop position in the station is stored in the database 21.

If such information indicating the given position as the final stop position is obtained, the target setting unit 32 performs a setting process for setting a plurality of targets until the train 1 is stopped in the given position (step S11). The setting process is a process for determining a plurality of targets to be sequentially reached until the given position is satisfied.

A plurality of targets described above may be stored in the database 21 in correspondence to the respective given positions. For example, it is considered efficient to previously store a plurality of targets used for control of stopping the train 1 in a fixed position of a station in a normal operation state in the database 21 or the like. In this case, the target setting unit 32 reads a plurality of targets corresponding to the fixed positions of the station from the database 21 and sets for controlling the train 1.

Further, a plurality of targets described above may be calculated by the target setting unit 32. In this case, the target setting unit 32 performs a setting process of calculating and setting a plurality of targets with the given position of the station set as a final stop target position based on the present position of the train 1, the present speed of the train 1, route data from the present position to the given position and vehicle data of the train 1 and the like. Further, the target setting unit 32 may calculate a distance between the respective targets that can realize highly efficient control in the setting process. In this case, as the distance between the respective targets, for example, a distance of the target positions in the respective targets or a distance in a 2-dimensional space of the position and speed or the like may be considered.

If a plurality of targets are set by the target setting unit 32, the control instructing unit 33 performs stop control by using the first target among a plurality of targets set as a present control target (step S12). That is, the control instructing unit 33 calculates a running schedule to reach the present control target and controls running and stopping of the train 1 according to the running schedule calculated. In such an operation state, the target setting unit 32 or control instructing unit 33 monitors the state variation of the train 1.

For example, when the train 1 stops at the station (in practice, when the final target is reached) (in step S13, YES), the target setting unit 32 sets a plurality of targets to set a preset given position of the next station as a final stop target in a section to the next station (step S14). In this case, control of stopping in the given position of the next station can be performed by performing the process from step S12. That is, the target setting unit 32 has function of calculating a plurality of targets in the next section at the stop time at the station and setting the targets.

Further, when an ATC signal received by the ATC device 15 via the ATC receiver 16 is changed (step S15, YES), the target setting unit 32 performs a process for resetting a plurality of targets set in step S11 according to a condition notified by the ATC signal (step S16). That is, the target setting unit 32 has a function of resetting the target that was already set during running according to the ATC signal.

Further, when the present control target is satisfied, the target setting unit 32 changes a target next to the target that has been satisfied among a plurality of targets set in step S11 to a control target (step S18). In this case, the target setting unit 32 notifies the changed control target to the control instructing unit 33. As a result, the control instructing unit 33 performs stop control by using the changed target as the present control target (step S12). That is, the control instructing unit 33 calculates a running schedule to satisfy the changed control target and controls operation (stopping) of the train 1 according to the calculated running schedule.

Further, the control instructing unit 33 may change a target value based on information from the control device 13 and control device 14. Additionally, the control instructing unit 33 may change the target value based on a signal from an external device such as the ATC device 15.

The automatic train controlling apparatus according to the embodiment described above sets a plurality of targets configured by combinations of speeds and positions to be sequentially reached until the train is stopped in the given position, sequentially changes a plurality of set targets as a control target to be satisfied, calculates a control instruction to satisfy the changed control target, and controls running of the train 1 according to the calculated control instruction. Further, when the control target is satisfied, the automatic train controlling apparatus calculates a control instruction for a control target to be next changed again and controls running of the train 1 according to the calculated control instruction.

According to the automatic train controlling apparatus according to the embodiment as described above, the behavior of a train until it is stopped in a given position can be finely controlled and highly efficient stop control can be realized. Further, since the degree of flexibility in setting a plurality of targets until the final stop target is satisfied is high, various operating configurations and requirements can be easily coped with.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fail within the scope and spirit of the inventions.

What is claimed is:

1. A vehicle controlling apparatus comprising:
a storage unit which stores plurality sets of target information;
a setting unit which sequentially sets at least part of the plurality of target information to be satisfied until a vehicle stops in a given position based on the part of the plurality of target information;
a changing unit which sequentially changes one target information to next target information in series in the part of the plurality of target information when the one target information is satisfied; and
a controller which controls an operation of the vehicle so that the operation satisfies the target set by the changing unit.

2. The vehicle controlling apparatus according to claim 1, wherein the target information is composed of position information and speed information.

3. The vehicle controlling apparatus according to claim 1, wherein the at least part of the plurality of target information set by the setting unit includes target information where the vehicle stops.

4. The vehicle controlling apparatus according to claim 1, wherein the setting unit calculates a permissible range for at least one of the part of the plurality of target information by multiplying the at least one of the part of the plurality of target information by a predetermined coefficient.

5. The vehicle controlling apparatus according to claim 1, further comprising an ATC device that receives an ATC signal supplied from a track on which the vehicle runs, and setting unit updates the part of the plurality of target information based on the ATC signal received by the ATC device.

6. A train, comprising:
a train body;
wheel units on which the train body is placed;
a storage unit which stores plurality sets of target information;
a setting unit which sequentially sets at least part of the plurality of target information to be satisfied until a vehicle stops in a given position based on the part of the plurality of target information;
a changing unit which sequentially changes one target information to next target information in series in the part of the plurality of target information when the one target information is satisfied; and
a controller which controls an operation of the vehicle so that the operation satisfies the target set by the changing unit.

7. The train according to claim 6, wherein the target information is composed of position information and speed information.

8. The train according to claim 6, wherein the at least part of the plurality of target information set by the setting unit includes target information where the vehicle stops.

9. The train according to claim 6, wherein the setting unit calculates a permissible range for at least one of the part of the plurality of target information by multiplying the at least one of the part of the plurality of target information by a predetermined coefficient.

10. The train according to claim 6, further comprising an ATC device that receives an ATC signal supplied from a track on which the vehicle runs, and setting unit updates the part of the plurality of target information based on the ATC signal received by the ATC device.
